(19) United States
(12) Patent Application Publication
(10) Pub. No.: US 2015/0163302 A1
(43) Pub. Date: Jun. 11, 2015

(54) SYNCHRONIZING CONTENT BETWEEN DEVICES

(71) Applicant: Asurion, LLC, Nashville, TN (US)

(72) Inventors: Andrew Armstrong, Martinez, CA (US); Shekar Mantha, San Francisco, CA (US); Martin Reed, San Francisco, CA (US); E. Jon Garcia, San Francisco, CA (US)

(73) Assignee: Asurion, LLC, Nashville, TN (US)

(21) Appl. No.: 14/099,480

(22) Filed: Dec. 6, 2013

(51) Int. Cl. H04L 29/08

(52) U.S. Cl. CPC H04L 67/1097; H04L 67/06

(57) ABSTRACT

Methods, systems, and apparatus include computer programs encoded on a computer-readable storage medium for transferring information between devices. A method includes: receiving at a transferring device and indication of an intent to transfer data from the transferring device to a receiving device; receiving at a receiving device an indication of an intent to receive the data from the transferring device; displaying by the receiving device a code responsive to the indicating by the receiving device; reading the code by the transferring device and prompting, including providing a first prompt to a user of the transferring device to confirm pairing with the receiving device; receiving a confirmation of the first prompt; providing a second prompt to a user of the receiving device to confirm pairing with the transferring device; and receiving a confirmation of the second prompt and initiating transfer of the data from the transferring device to the receiving device.

### BACKGROUND

This specification relates to transferring information between devices.

A backup procedure can be used to archive information associated with an electronic device. Important information, such as included in a set of files, can be copied to a backup device or to an external medium. Data can be copied not only to different medium but to a medium located at a different location than the electronic device, to protect both against media failure and against other threats, such as natural disasters. For example, a cloud-based backup procedure can be used, in which information is copied from an electronic device to a server accessible via the Internet.

### SUMMARY

In general, one innovative aspect of the subject matter described in this specification can be implemented in methods that include a method for transferring information between devices. The method comprises: indicating by a transferring device an intent to transfer data from the transferring device to a receiving device; indicating by a receiving device an intent to receive the data from the transferring device; displaying by the receiving device a code responsive to the indicating by the receiving device; reading the code by the transferring device and prompting, including providing a first prompt to a user of the transferring device to confirm pairing with the receiving device; receiving a confirmation of the first prompt; providing a second prompt to a user of the receiving device to confirm pairing with the transferring device; and receiving a confirmation of the second prompt and initiating transfer of the data from the transferring device to the receiving device.

In general, another aspect of the subject matter described in this specification can be implemented in computer program products. A computer program product is tangibly embodied in a computer-readable storage device and comprises instructions. The instructions, when executed by a processor, cause the processor to: indicate by a transferring device an intent to transfer data from the transferring device to a receiving device; indicate by a receiving device an intent to receive the data from the transferring device; display by the receiving device a code responsive to the indicating by the receiving device; read the code by the transferring device and prompting, including providing a first prompt to a user of the transferring device to confirm pairing with the receiving device; receive a confirmation of the first prompt; provide a second prompt to a user of the receiving device to confirm pairing with the transferring device; and receive a confirmation of the second prompt and initiating transfer of the data from the transferring device to the receiving device.

In general, another aspect of the subject matter described in this specification can be implemented in systems. A system includes: one or more processors and one or more memory elements including instructions. The instructions, when executed, cause the one or more processors to: indicate by a transferring device an intent to transfer data from the transferring device to a receiving device; indicate by a receiving device an intent to receive the data from the transferring device; display by the receiving device a code responsive to the indicating by the receiving device; read the code by the transferring device and prompting, including providing a first prompt to a user of the transferring device to confirm pairing with the receiving device; receive a confirmation of the first prompt; provide a second prompt to a user of the receiving device to confirm pairing with the transferring device; and receive a confirmation of the second prompt and initiating transfer of the data from the transferring device to the receiving device.

These and other implementations can each optionally include one or more of the following features. The data can be selected from the group comprising contact data, a data file, a video, an image, or other transferring device resident data. Prior to transfer, data format requirements of the receiving device can be determined, and the data can be translated into a generic format prior to transmission to the receiving device. The generic format of the data can be received and converted into a device specific format that is compatible with the receiving device. The generic format can be in the extensible mark-up language (XML). The data can be received at the receiving device. A context associated with the received data can be determined. The received data can be stored in the context including storing the received data at a location and in a form that is consistent with other similar data that is natively captured by the receiving device including storing consistent data in a location that the other similar data is stored. The stored consistent data can be made available to applications on the receiving device similar to the other similar data that is natively captured by the receiving device. The transferring device and the receiving device can include different operating systems. Authentication information can be provided to a central service by the receiving device prior to presentation of the code by the receiving device. The code can be a quick response (QR) code and the reader can be a camera on the transferring device. An application can be loaded on each of the transferring device and the receiving device and an indication to execute the application can be received. Execution of the application can produce the code and the prompts and can initiate the transfer of the data. A determination can be made that the data in the transferring device needs to be backed up. One or more characteristics of either the data to be backed up or the availability or capability of the transferring device to back up the data directly to a cloud based central system can be determined that indicates direct back up should not occur. In response to the determining the one or more characteristics the transfer of data to the receiving device can be initiated rather than directly to the cloud based central system. After receipt by the receiving device of the data, the data can be transferred to the cloud based central system by the receiving device. The receiving device can be a personal computer, a tablet or gateway to the cloud based central system and the transferring device can be a mobile device.

Particular implementations may realize none, one or more of the following advantages. Data can be transferred directly from a transferring device to a receiving device using one connection path rather than using an intermediary device and two connection paths. Transferring data using one connection path can be faster than transferring data using two connection paths. Transferring data using a local network can be faster than transferring data using a network such as the Internet. A fastest backup operation can be automatically selected between backing up data to a central server or to a local receiving device. Large data files, such as associated with images or videos, can be efficiently and economically transferred directly between devices without using network bandwidth (e.g., cellular) and without regard for file size restrictions or limitations.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for transferring information between devices.

FIG. 2 is a flowchart of an example process for transferring information between devices.

FIG. 3 is a flowchart of an example process for storing data at a receiving device.

FIG. 4 is a flowchart of an example process for backing up data.

FIG. 5 illustrates example transferring and receiving device user interfaces in various stages of a transfer operation.

FIG. 6 is a flowchart of an example process for transferring data between devices.

FIG. 7 is a block diagram of computing devices that may be used to implement the systems and methods described in this document, as either a client or as a server or plurality of servers.

Like reference numbers and designations in the various drawings indicate like elements.

### DETAILED DESCRIPTION

A user may desire to transfer data from a first electronic (e.g. mobile) device to a second electronic (e.g., mobile) device. For example, the user may have upgraded to the second mobile device. Rather than transferring data from the first mobile device to an intermediary server and then from the intermediary server to a second mobile device, the user can transfer data directly from the first mobile device to the second mobile device, which can result in a faster and more reliable/efficient transfer operation. The first and the second electronic devices are not required to be compatible, or support a same operating system. The data that is transferred can be translated as required depending on the different requirements of the given devices. Further, once transferred, the data can be made available on the receiving device just as other data that is of the same type that was natively captured/present on the receiving device.

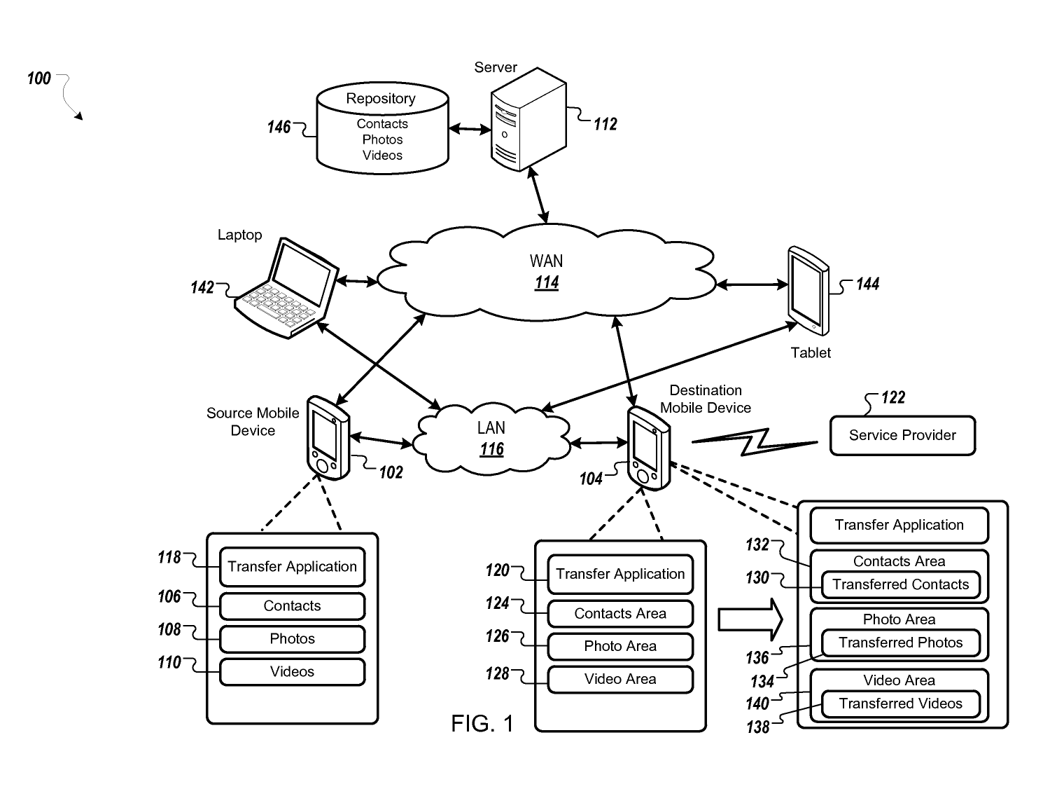

FIG. 1 is a block diagram of an example system 100 for transferring data between devices. A user may desire to transfer data from a source mobile device 102 (e.g., a transferring device) to a destination mobile device 104 (e.g., a receiving device). For example, the user may desire to transfer contacts 106, photographs 108, videos 110, and/or other data. The source mobile device 102 may be a different type of device (e.g., hardware and/or operating system) than the destination mobile device 104.

Data can be transferred from the source mobile device 102 to the destination mobile device 104 using a server 112 as an intermediary device. For example, data can be first transferred from the source mobile device 102 to the server 112 over a WAN (Wide Area Network) 114, such as the Internet, and then transferred from the server 112 to the destination mobile device 104 over the WAN 114. Transferring data using the server 112 as an intermediary device involves two connection paths (e.g., from the source mobile device 102 to the server 112, and from the server 112 to the destination mobile device 104). Transferring data over two connection paths can be slower, more costly and potentially less reliable as compared to transferring data over one connection path (e.g., as described below).

As an alternative to transferring data using the server 112 as an intermediary device, data can be transferred directly from the source mobile device 102 to the destination mobile device 104 using a direct communication link, such as over a LAN (Local Area Network) 116. The LAN can be associated with a wireless network including a WIFI direct, Bluetooth®, near field or other wireless network. In some implementations, a determination can be made regarding whether a transfer directly from the source mobile device 102 to the destination mobile device 104 is desirable (e.g., likely to be faster) than a transfer using the server 112 as an intermediary device. When desirable, the user can be prompted to configure and initiate the direct transfer.

For example, a transfer application 118 can be installed on the source mobile device 102 and a transfer application 120 can be installed on the destination mobile device 104. The user can select a user interface control presented by the transfer application 118 to indicate an intent to transfer data from the source mobile device 102 to the destination mobile device 104. Similarly, the user can select a user interface control presented by the transfer application 120 to indicate an intent to receive data by the destination mobile device 104 from the source mobile device 102. The user can select one or more types of data to transfer. For example, the user can specify to transfer the contacts 106, the photographs 108, and the videos 110.

In some implementations, the destination device can be authenticated before the transfer begins. Authentication can be performed, for example, to prevent unauthorized transfers of data (e.g., a first user in proximity to a second user transferring data to a mobile device of the second user without authorization or consent of the second user, or transfer to a device that is not an acceptable receiving device). In some implementations, the destination mobile device 104 can display a code (e.g., a QR (Quick Response) code) and the source mobile device 102 can read the code as part of an authentication process. For example, a camera included in the source mobile device 102 can read the code. In some implementations, the destination mobile device 104 can send a message (e.g., an SMS (Short Message Service) message) to a service provider 122. For example, the service provider 122 can be associated with the transfer application 120. The service provider 122 can verify that an account associated with the destination mobile device 104 exists and that the device type of the destination mobile device 104 is supported. In some implementations, a phone naming system is used for authentication. In some implementations, the destination mobile device 104 can be authenticated when the transfer application 120 is installed. In some implementations, the source mobile device 102 and the destination mobile device 104 exchange security certificates and a determination is made that the certificates match. Other forms of authentication are possible.

In order to transfer data, the source mobile device 102 is paired with the destination mobile device 104. For example, a first prompt can be displayed on the source mobile device 102 to confirm pairing with the destination mobile device 104 and a second prompt can be displayed on the destination mobile device 104 to confirm pairing with the source mobile device 102. The user can confirm the first and second prompts. In some implementations, the source mobile device 102 performs a discovery process to identify potential nearby destination devices. The user can confirm (e.g., select) a destination device, the selected destination device can be authenticated, and the selected destination device can be paired with the source mobile device 102.

The transfer application 120 can identify one or more locations on the destination mobile device 104 in which to store received data. For example, the transfer application 120 can identify a contacts area 124 in which to store received contact data, a photographs area 126 in which to store received photographs, and a video area 128 in which to store received videos. After receiving confirmation of the first and second prompts, the selected data items can be transferred from the source mobile device 102 to the destination mobile device 104 over the WAN 116. For example, the contacts 106 can be transferred and stored in the contacts area 124, as illustrated by transferred contacts 130 included in an updated contacts area 132, the photographs 108 can be transferred and stored in the photographs area 126, as illustrated by transferred photographs 134 included in an updated photographs area 136, and the videos 110 can be transferred and stored in the videos area 128, as illustrated by transferred videos 138 included in an updated videos area 140.

Reports can be provided, such as to the user and/or to the service provider 122. For example, reports can indicate what data has been transferred and between which devices. Reports can also indicate whether any errors or other conditions were encountered during a transfer operation. For example, some data may not be successfully transferred due to lack of available storage space on the destination mobile device 104. As another example, a report can include messages indicating that some data items were not transferred due to duplicate data items already existing on the destination mobile device 104.

In addition to transferring data from the source mobile device 102 to the destination mobile device 102, data can be transferred to other types of receiving devices, such as a laptop 142 or a tablet computer 144. For example, the laptop 142 and/or the tablet computer 144 can be used by the user to back up data from the source mobile device 102. For example, a back-up procedure can be performed, either automatically on a scheduled basis or in response to user input.

A back-up application can determine whether backing up data to the laptop 142 or the tablet computer 144, or to the server 112, would be more desirable. When, upon initiation of the back-up procedure, a connection exists, for example, between the laptop 142 and the source mobile device 102 over the LAN 116, and when a determination is made that backing up data to the laptop 142 would be more desirable (e.g., faster, cheaper) than backing up data to the server 112, data from the source mobile device 102 can be backed up to the laptop 142. In some implementations, at a predetermined time, data backed up to the laptop 142 can be transferred to the server 112 and stored, for example, in a repository 146. When, upon initiation of the back-up procedure, a connection between the laptop 142 and the source mobile device 102 does not exist, such as when the user is at a location different than the location of the laptop 142, or when a determination is made that backing up data directly to the server 112 would be more desirable than backing up data to the laptop 142, data from the source mobile device 102 can be backed up directly to the server 112. A synchronization service provided by the server 112 can synchronize data for the user, such as data transferred directly from the source mobile device 102 to the server 112 and data transferred from the laptop 142 to the server 112.

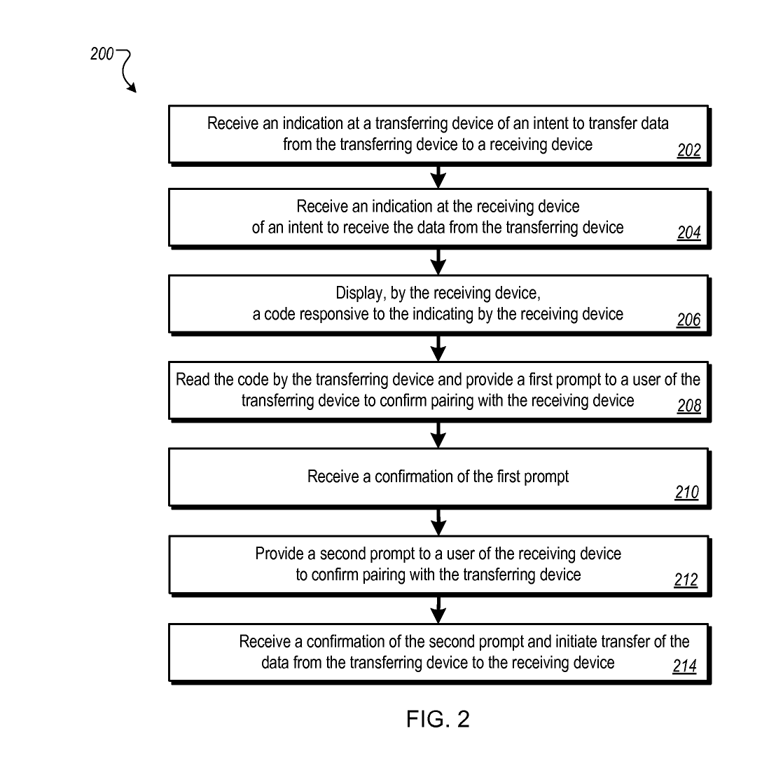

FIG. 2 is a flowchart of an example process 200 for transferring data between devices. The process 200 can be performed, for example, by the system 100 described above with respect to FIG. 1.

An indication is received at a transferring device of an intent to transfer data from the transferring device to a receiving device (202). The data can include, for example, one or more of contact data, a data file, a video, an image, or other transferring device resident data. The transferring device and the receiving device can each be mobile devices, for example, or can be other types of devices. The transferring device and the receiving device can include different operating systems. The indication can be, for example, the initiation of a data transfer application by a user of the transferring device, or more specifically, the processing of a user input in the data transfer application received by the transferring device, where the user input indicates a request to perform a data transfer operation from the transferring device to the receiving device.

An indication is received at the receiving device of an intent to receive the data from the transferring device (204). The indication can be, for example, the initiation of a data transfer application by a user of the receiving device, or more specifically, the processing of a user input in the data transfer application received by the receiving device, where the user input indicates a request to perform a data transfer operation from the transferring device to the receiving device.

A code is displayed by the receiving device responsive to the indicating by the receiving device (206). The code can be, for example, a quick response (QR) code. The code can be displayed on a user interface associated with the data transfer application.

The code is read by the transferring device and the transferring device provides a first prompt to a user of the transferring device to confirm pairing with the receiving device (208). The code can be read, for example, by a camera included in the transferring device. The transferring device can read the code, for example, to confirm that data will be transferred to a known destination device.

A confirmation of the first prompt is received (210). For example, the transferring device can receive a user input as a confirmation of the first prompt.

A second prompt is provided to a user of the receiving device to confirm pairing with the transferring device (212).

A confirmation of the second prompt is received and transfer of the data from the transferring device to the receiving device is initiated (214). In some implementations and/or for some types of data, the data from the transferring device can be converted (e.g., transformed) into a generic format, such as XML (eXtensible Markup Language) prior to transfer. For example, one or more data items (e.g., fields) in the transferring device data can be mapped to one or more data items in the generic format. The data from the transferring device can be transformed, for example, due to differences in data elements or formatting between the transferring device and the receiving device (e.g., due to hardware and/or operating system differences). Some data items, such as photographs and videos, can be transferred as binary objects. In some implementations, metadata can be transferred in association with a binary object. In some implementations, the data from the transferring device can be encrypted before the data is sent to the receiving device. In some implementations, a hash value is computed based on the to be transferred data and is transferred along with the data.

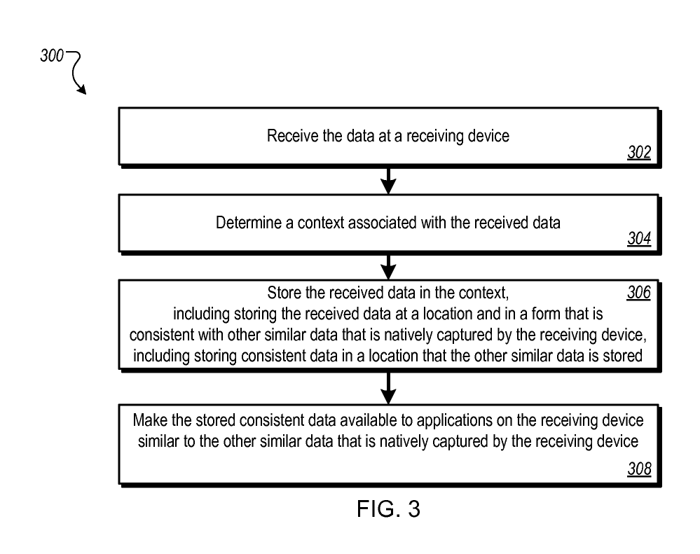

FIG. 3 is a flowchart of an example process 300 for processing data at a receiving device. The process 300 can be performed, for example, by the system 100 described above with respect to FIG. 1.

Data is received at a receiving device (302). The data can be received, for example, from a transferring device. The data can include, for example, one or more of contact data, a data file, a video, an image, or other transferring device resident data. The data can be received in a generic format (e.g., XML) and the generic format of the data can be converted into a device-specific format that is compatible with the receiving device. For example, a receiving-device-specific format for contact data, videos, or images can be identified. The received data can be encrypted and can be decrypted after being received. In some implementations, a first hash value is received with the data and a second hash value is computed based on the received data and a determination is made as to whether the first hash value matches the second hash value. If the first hash value does not match the second hash value, an error condition can be reported.

A context associated with the received data is determined (304). For example, the context can indicate a location where other similar data that is natively captured by the receiving device is stored. For example, when the data is contact data, a location where contact data is stored on the receiving device can be identified.

The received data is stored in the context including storing the received data at the location and in a form that is consistent with other similar data that is natively captured by the receiving device, including storing consistent data in a location that the other similar data is stored (306). For example, image data can be stored in a receiving-device-specific image format and at a location where natively captured images are stored on the receiving device.

The received data can be stored so as to avoid creating duplicate data items on the receiving device. For example, before storing a data item, a determination can be made that a duplicate data item (e.g., a same photograph, a same contact) does not exist on the receiving device. If a duplicate data item exists on the receiving device, the received data item may not be stored on the receiving device (e.g., an error can be reported or other action can be taken).

The stored consistent data is made available to applications on the receiving device similar to the other similar data that is natively captured by the receiving device (308). For example, image data can be made available to one or more image-viewing applications and contact-data can be made available to one or more applications that display contact information. The user can view and interact with received data, such as contacts, videos, or images, as if such data items were captured or created natively by the receiving device.

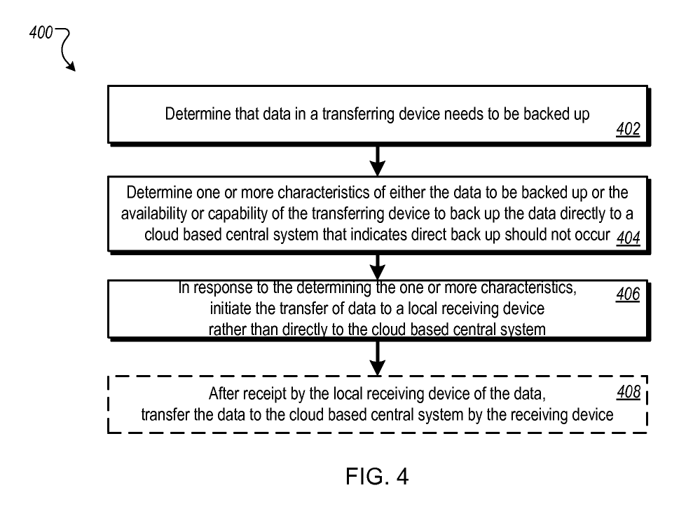

FIG. 4 is a flowchart of an example process 400 for backing up data. The process 400 can be performed, for example, by the system 100 described above with respect to FIG. 1.

A determination is made that the data in a transferring device needs to be backed up (402). The transferring device can be, for example, a mobile device. The data can include, for example, one or more of contact data, a data file, a video, an image, or other transferring device resident data. The determination can be based for example, on a difference between a previous backup time and the current time being more than a threshold number of days (e.g., ten days, thirty days). As another example, the determination can be based on receiving a user input requesting a backup operation to be performed.

One or more characteristics of either the data to be backed up or the availability or capability of the transferring device to back up the data directly to a cloud based central system are determined that indicates direct back up should not occur (404). For example, an estimated connection speed of backing up the data directly to the cloud based central system can be determined and can be compared to an estimated connection speed of backing up the data to a local receiving device, e.g., over a local network. The local receiving device can be, for example, a personal computer, a tablet computer, or a gateway to the cloud based central system.

As another example, an estimated backup transfer time of backing up the data directly to the cloud based central system can be determined and can be compared to an estimated transfer time of backing up the data to the receiving device. When a connection can be made to the receiving device over the local network, and when the connection speed associated with the backup to the receiving device is higher than the connection speed associated with the backup to the cloud based central system and/or when the transfer time associated with the backup to the receiving device is less than the transfer time associated with the backup to the cloud based central system, a determination can be made to not backup the data directly to the cloud based system but to rather backup the data to the receiving device.

In response to determining the one or more characteristics, the transfer of data to the local receiving device rather than directly to the cloud based central system is initiated (406). For example, the data to be backed up can be transferred to the local receiving device over the local network.

In some implementations, after receipt by the local receiving device of the data, the data can be subsequently transferred to the cloud based central system by the local receiving device, such as when conditions are favorable (408). For example, the data can be transferred at a predetermined time, such as on a nightly or weekly schedule. For example, a transfer process can run on the local receiving device overnight and can transfer data received from the transferring device (if such data exists on the receiving device) to the cloud based central system, such as over the Internet.

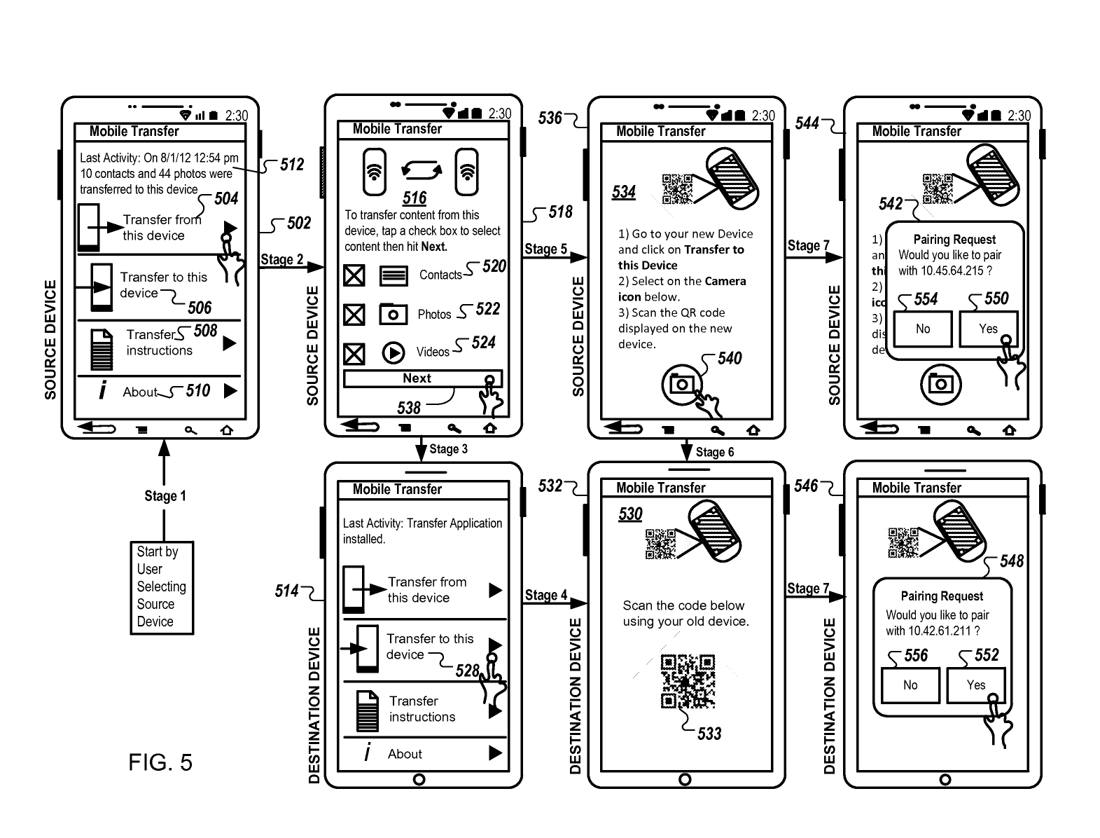

FIG. 5 illustrates example transferring and receiving device user interfaces in various stages of a transfer operation. In a first stage, the user opens a transfer application on a source device 502. The user can select a control 504 to select a transfer operation for transferring data from the source device 502 to another device. A control 508 can be selected to display more detailed transfer instructions. A control 510 can be selected to display information about the transfer application. A message 512 provides information about a last transfer operation involving the source device 502. For example, the message 512 indicates that on Aug. 1, 2012, a transfer operation was performed which resulted in the transferring of ten contacts and forty four pictures to the source device 502.

In a second stage, the user selects the control 504 to select a transfer operation for transferring data from the source device 502 to a destination device 514. In response to selection of the control 504, a content type selection interface 516 is displayed, as shown on a source device 518. The user can select one or more content types to transfer. For example, controls 520, 522, and 524 are selected, corresponding to content types of contacts, photos, and videos, respectively.

In a third stage, the user opens a transfer application on the destination device 514. A control 528 can be selected to indicate that data is to be transferred to the destination device 514. In a fourth stage, a user interface 530 is displayed in response to selection of the control 528, as illustrated on a destination device 532. The user interface 530 includes a code (e.g., QR code) 533.

In a fifth stage, a user interface 534 is displayed (e.g., on a source device 536), in response to selection of a control 538. In a sixth stage, the user can select a camera icon 540 to initiate a scan process wherein a camera included in the source device 536 captures an image of the code 533 displayed on the destination device 532. In a sixth stage, the camera scans the code 533.

In a seventh stage, a message 542 is displayed (e.g., on a source device 544). The message 542 prompts the user whether the user wants to pair the source device 544 with a destination device (e.g., a destination device 546) having an IP (Internet Protocol) address of 10.45.64.215. In some implementations, rather than displaying an IP address associated with a given device, a name of the device can be provided. A message 548 similar to the message 542 is displayed on the destination device 546. If the user confirms the pairing request, such as by respectively selecting controls 550 and 552, transfer of data of the selected content types is performed from the source device 544 to the destination device 546. If the user declines the pairing request, such as by selecting a control 554 and/or a control 556, the transfer operation is canceled.

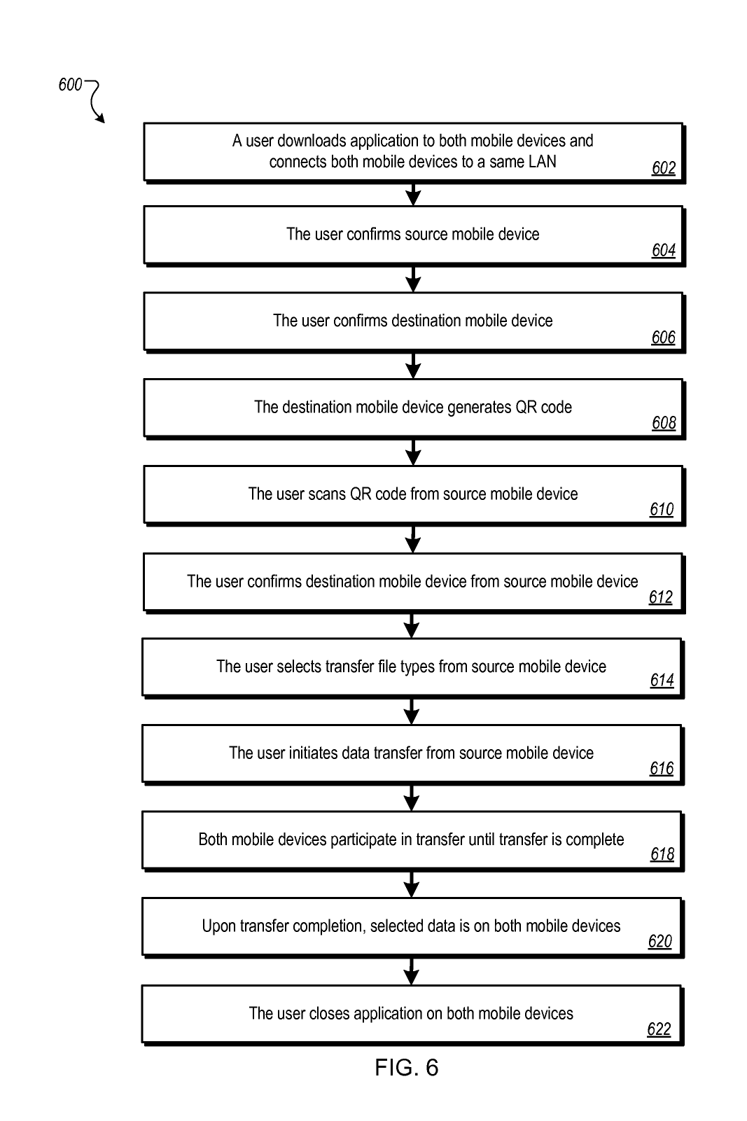

FIG. 6 is a flowchart of an example process 600 for transferring data between devices. The process 600 can be performed, for example, by the system 100 described above with respect to FIG. 1.

The user downloads an application to both a source mobile device and to a destination mobile device and connects both the source mobile device and the destination mobile device to a LAN (Local Area Network)(602). The LAN can be, for example, a local wireless network.

The user confirms the source mobile device (604). For example, the user can select, from within the application, a user interface control on the source mobile device which indicates that the user would like to transfer data from the source mobile device.

The user confirms the destination mobile device (606). For example, the user can select, from within the application, a user interface control on the destination mobile device which indicates that the user would like to transfer data to the destination mobile device.

The destination mobile device generates a quick response (QR) code (608). The QR code can be displayed on the display of the destination mobile device.

The user scans the QR code from the source mobile device (610). For example, the user can scan the QR code displayed on the destination mobile device using a camera included in the source mobile device.

The user confirms the destination mobile device from the source mobile device (612). For example, the user can respond to a prompt displayed on the source mobile device which asks the user to confirm pairing with the destination mobile device.

The user selects transfer file types from the source mobile device (614). File types can include, for example, contact data, photos, videos, or other types of data that is stored on the source mobile device. The user can select one or more user interface controls on the source mobile device that each correspond to a respective file type or type of data to transfer.

The user initiates a data transfer from the source mobile device (616). For example, the user can select a user interface control, from within the application user interface displayed on the source mobile device, to initiate the data transfer.

Both the source mobile device and the destination mobile device participate in the data transfer until the data transfer is complete (618). For example, data can be transferred from the source mobile device to the destination mobile device over the LAN.

Upon transfer completion, the selected data is on both the source mobile device and the destination mobile device (620). For example, the data can be stored on the destination mobile device at a location and in a form that is consistent with other similar data that is natively captured by the destination mobile device.

The user closes the application on the source mobile device and the application on the destination mobile device (622). For example, the user can select a user interface control from within each application to close the application on each of the source mobile device and the destination mobile device.

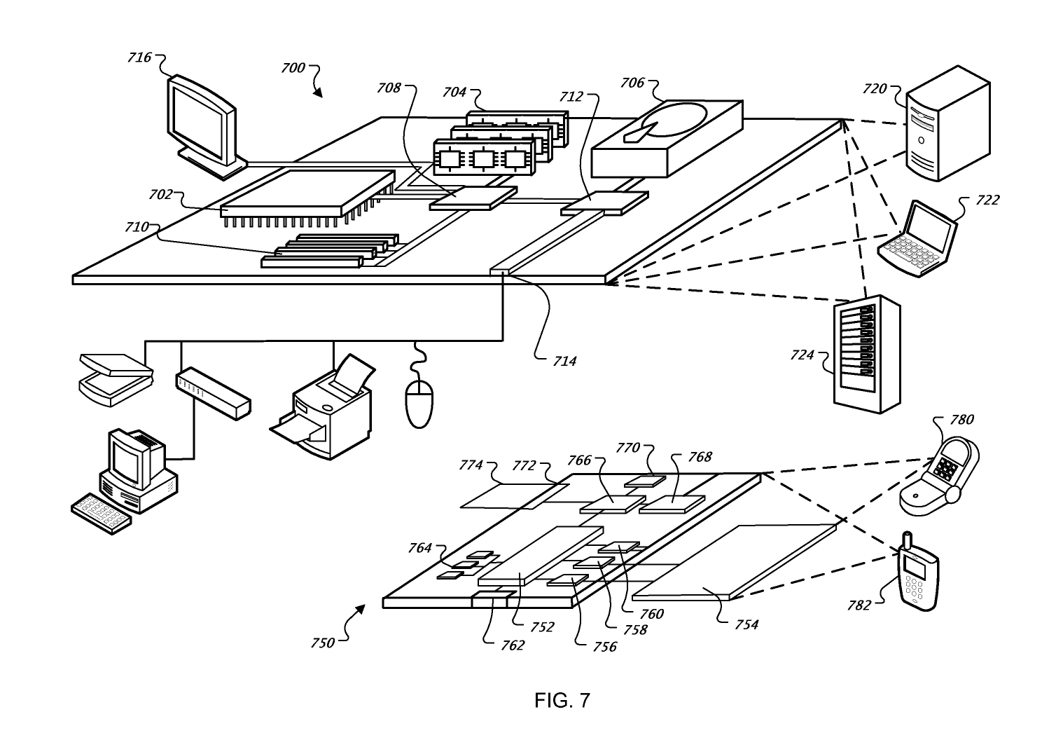

FIG. 7 is a block diagram of computing devices 700, 750 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a non-transitory computer-readable medium. The computer-readable medium is not a propagating signal. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of duties is illustrative only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD display or an OLED display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication (e.g., via a docking procedure) or for wireless communication (e.g., via Bluetooth or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS receiver module 770 may provide additional wireless data to device 750, which may be used as appropriate by applications running on device 750.

Device 750 may also communication audibly using audio codec 760, which may receive spoken information from a user and convert it to usable digital information. Audio codex 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the systems and methods have been described, it should be recognized that numerous other applications are contemplated. Accordingly, other embodiments are within the scope of the following claims.

What is claimed is:

1. A method comprising:
receiving at a transferring device an indication of an intent to transfer data from the transferring device to a receiving device;
receiving at a receiving device an indication of an intent to receive the data from the transferring device;
displaying by the receiving device a code responsive to the indicating by the receiving device;
reading the code by the transferring device and prompting, including providing a first prompt to a user of the transferring device to confirm pairing with the receiving device;
receiving a confirmation of the first prompt;
providing a second prompt to a user of the receiving device to confirm pairing with the transferring device; and
receiving a confirmation of the second prompt and initiating transfer of the data from the transferring device to the receiving device.

2. The method of claim 1 wherein the data is selected from the group comprising contact data, a data file, a video, an image, or other transferring device resident data.

3. The method of claim 1 further comprising prior to transfer, determining data format requirements of the receiving device, and translating the data into a generic format prior to transmission to the receiving device, wherein the method further comprises receiving the generic format of the data and converting the generic format of the data into a device specific format that is compatible with the receiving device.

4. The method of claim 3 wherein the generic format is in the extensible mark-up language (XML).

5. The method of claim 1 further comprising:
receiving the data at the receiving device;
determining a context associated with the received data; and
storing the received data in the context including storing the received data at a location and in a form that is consistent with other similar data that is natively captured by the receiving device including storing consistent data in a location that the other similar data is stored.

6. The method of claim 5 further comprising making the stored consistent data available to applications on the receiving device similar to the other similar data that is natively captured by the receiving device.

7. The method of claim 1 wherein the transferring device and the receiving device include different operating systems.

8. The method of claim 1 further comprising providing authentication information to a central service by the receiving device prior to presentation of the code by the receiving device.

9. The method of claim 1 wherein the code is a quick response (QR) code and the reader is a camera on the transferring device.

10. The method of claim 1 further comprising loading an application on each of the transferring device and the receiving device and receiving an indication to execute the application, wherein execution of the application produces the code and the prompts and initiates the transfer of the data.

11. The method of claim 1 further comprising
determining that the data in the transferring device needs to be backed up;
determining one or more characteristics of either the data to be backed up or the availability or capability of the transferring device to back up the data directly to a cloud based central system that indicates direct back up should not occur; and
in response to the determining the one or more characteristics initiating the transfer of data to the receiving device rather than directly to the cloud based central system.

12. The method of claim 11 further comprising, after receipt by the receiving device of the data, transferring the data to the cloud based central system by the receiving device.

13. The method of claim 12 wherein the receiving device is a personal computer, a tablet or gateway to the cloud based central system and wherein the transferring device is a mobile device.

14. A computer program product tangibly embodied in a computer-readable storage device and comprising instructions that, when executed by a processor, cause the processor to:
receive at a transferring device and indication of an intent to transfer data from the transferring device to a receiving device;
receive at a receiving device an indication of an intent to receive the data from the transferring device;
display by the receiving device a code responsive to the indicating by the receiving device;
read the code by the transferring device and prompting, including providing a first prompt to a user of the transferring device to confirm pairing with the receiving device;
receive a confirmation of the first prompt;
provide a second prompt to a user of the receiving device to confirm pairing with the transferring device; and
receive a confirmation of the second prompt and initiating transfer of the data from the transferring device to the receiving device.

15. The product of claim 14 wherein the data is selected from the group comprising contact data, a data file, a video, an image, or other transferring device resident data.

16. The product of claim 14, further comprising instructions that, when executed by the processor, cause the processor to:
determine, prior to transfer, data format requirements of the receiving device;
translate the data into a generic format prior to transmission to the receiving device;
receive the generic format of the data; and
convert the generic format of the data into a device specific format that is compatible with the receiving device.

17. A system comprising:
one or more processors; and
one or more memory elements including instructions that when executed cause the one or more processors to:
receive at a transferring device and indication of an intent to transfer data from the transferring device to a receiving device;
receive at a receiving device an indication of an intent to receive the data from the transferring device;
display by the receiving device a code responsive to the indicating by the receiving device;
read the code by the transferring device and prompting, including providing a first prompt to a user of the transferring device to confirm pairing with the receiving device;
receive a confirmation of the first prompt;
provide a second prompt to a user of the receiving device to confirm pairing with the transferring device; and
receive a confirmation of the second prompt and initiating transfer of the data from the transferring device to the receiving device.

18. The system of claim 17 wherein the data is selected from the group comprising contact data, a data file, a video, an image, or other transferring device resident data.

19. The system of claim 17, the one or more memory elements further including instructions that when executed cause the one or more processors to:
determine, prior to transfer, data format requirements of the receiving device;
translate the data into a generic format prior to transmission to the receiving device;
receive the generic format of the data; and
convert the generic format of the data into a device specific format that is compatible with the receiving device.

20. The system of claim 19 wherein the generic format is in the extensible mark-up language (XML).
